(19) United States
(12) Patent Application Publication
(10) Pub. No.: US 2012/0154917 A1
(43) Pub. Date: Jun. 21, 2012

(54) COLOR-SHIFTING REFLECTOR

(76) Inventor: Eric William Hearn TEATHER, Elkton, MD (US)

(21) Appl. No.: 13/352,854

(22) Filed: Jan. 18, 2012

Related U.S. Application Data
(60) Provisional application No. 61/433,764, filed on Jan. 18, 2011.

(51) Int. Cl. G02B 1/10

(52) U.S. Cl. 359/584

(57) ABSTRACT

A diffusive light reflector with a color-shifting layer for use with LED lighting systems is disclosed. The color-shifting layer shifts higher CCT LED light (e.g. 5000 Kelvin) to lower CCT LED light (e.g. 4000 Kelvin), thereby producing a “warmer” and “whiter” LED light. Also disclosed is a method of shifting low wavelength LED light to higher wavelengths using a diffusive light reflector with a color-shifting layer.

### CROSS REFERENCE TO RELATED APPLICATION

This application claims priority to United States provisional application for patent Ser. No. 61/433,764 filed Jan. 18, 2011, the entire contents of which are incorporated herein by reference.

### FIELD OF THE INVENTION

The invention relates to the lighting industry in general, and specifically to diffuse light reflectors with a photoluminescent layer for use in LED lighting applications. Also disclosed is a method of shifting light color of a LED by using a diffusive light reflector with a photoluminescent layer.

### BACKGROUND OF THE TECHNOLOGY

Light emitting diodes (LED) are becoming increasingly popular because of their efficiency and longevity. A LED is a semiconductor light source that can emit light across the visible, ultraviolet, and infrared wavelengths with very high brightness. The semiconductor can be made from a variety of inorganic materials and organic materials (a.k.a. OLED). Luminous efficiency of LEDs can range from 18-22 lumens per watt to around 130 lumens per watt for a white LED made by Cree Inc.

White LED lights are typically made in two ways. One way is to mix individual red, green, and/or blue LEDs to form white light. This is known as an RGB LED system and is typically found in high-end LCD TVs. Another is to use a phosphor (photoluminescent) material to convert monochromatic light from a blue or ultraviolet LED to a broad-spectrum white light.

RGB LED systems require individual electronic circuits to control the blending and diffusion of the different colors. The individual electronic circuits add to the complexity and cost of RGB LED systems. Further, luminous efficiency decreases as the number of individual LED colors increases. For example, a two color LED (di-chromatic) has a luminous efficiency of around 120 lumens per watt, while a three color LED (tri-chromatic) has a luminous efficiency of around 70 lumens per watt.

Phosphor-based LEDs use a phosphor based coating on the LED comprising different colors to form white light. A portion of the blue light from a blue LED undergoes Stokes Shift, whereby the shorter wavelengths are transformed to longer wavelengths. Phosphors of different colors can be employed and several layers can be applied to emit a broad spectrum of light and shift the wavelength of “cooler” blue light to a “warmer” white light with a higher wavelength.

Reflectors are used in numerous types of lighting fixtures to maximize the usable light, thus increasing the lighting efficiency. Maximization is achieved through a combination of reflecting and redirecting light generated by the lamp in a desired direction, and minimizing the light absorbed by the reflector. This is particularly important when the light fixture design includes a light cavity in which light rays are redirected multiple times within the cavity before exiting the light fixture as usable light. Fixtures that use reflectors include tubular fluorescent lamps and LEDs.

### SUMMARY OF THE INVENTION

Phosphor-based LEDs have several disadvantages, including lower efficiency than normal LEDs due to the heat loss from the Stokes Shift and phosphor heat related degradation issues. Additionally, multiple layers of phosphor are required to produce a “warmer”, lower color temperature (<4000 Kelvin), which in turn further reduces the efficiency of the LED system due to quantum losses. Also, small variations on the phosphor LED coating can lead to color variations, which make the LEDs unsuitable for certain applications that require uniform white light. This leads to increased cost, yield loss, and excessive inventories. Further, the reflectors in LED light fixtures often have a reduction in reflectance below 420 nm, which is within the range emitted by blue LEDs. This leads to absorption by the reflector of a portion of the blue LED light, which decreases lighting efficiency. Therefore, it would be desirable to eliminate the phosphor coating on the LED and convert the lower wavelength blue LED light to a higher wavelength prior to reflectance to avoid absorption by the reflector. This would reduce the heat degradation of the phosphor coating, permit a wider range of LEDs to be used, and improve reflector efficiency.

The invention disclosed herein provides a diffusive light reflector with a photoluminescent (phosphor) layer for use in LED lighting applications. In one aspect, a diffusive light reflector is disclosed comprising a sheet substrate having a first side and second side, wherein the first side is adapted to be adjacent to a LED light source; and a color shifting layer on the first side. The color shifting layer can comprise an optically transparent binder. The sheet substrate can be a plexifilimentary film fibril sheet, microporous PET sheet, foamed microcellular polyolefin (PET or PP), highly pigmented plastic sheet or expanded polytetrafluoroethylene (ePTFE) sheet. Further, an optional polymer layer can be disposed between the first side and the color shifting layer.

In another aspect, a laminate is disclosed, which comprises a sheet substrate with a color shifting layer, affixed to a steel, aluminum, or plastic sheet. The laminate can be affixed using numerous known techniques, including bonding with a melt adhesive comprising polyethylene or methacrylate, including low density polyethylene or acrylic. The sheet substrate can be a plexifilimentary film fibril sheet, microporous PET sheet, foamed microcellular polyolefin (PET or PP), highly pigmented plastic sheet or expanded polytetrafluoroethylene (ePTFE) sheet.

In a further aspect, a lighting fixture is disclosed, which comprises a laminate comprising a sheet substrate with a color shifting layer, affixed to a steel or aluminum sheet. The light fixture can include luminaires, lighted signs, daylighting reflectors, and backlights. The sheet substrate can be a plexifilimentary film fibril sheet, microporous PET sheet, foamed microcellular polyolefin (PET or PP), highly pigmented plastic sheet or expanded polytetrafluoroethylene (ePTFE) sheet

In yet another aspect, a liquid crystal display (LCD) panel is disclosed comprising a backlight, which comprises a sheet substrate with a color shifting layer, affixed to a steel, aluminum, or plastic sheet. The sheet substrate can be a plexifilimentary film fibril sheet, microporous PET sheet, foamed microcellular polyolefin (PET or PP), highly pigmented plastic sheet or expanded polytetrafluoroethylene (ePTFE) sheet.

In yet another aspect, a method of color shifting blue LED light is disclosed, which comprises: (a) directing light from a LED light source onto a diffusive light reflector, wherein the reflector comprises a color shifting layer and the LED light source has a CCT value of greater than 5000 Kelvin; (b) shifting a portion of the blue LED light to a longer wavelength; and (c) reflecting the longer wavelength light. The diffusive light reflector can comprise a sheet substrate with a color shifting layer and an optional polymer layer between the sheet and color shifting layer. The sheet substrate can be a plexifilimentary film fibril sheet, microporous PET sheet, foamed microcellular polyolefin (PET or PP), highly pigmented plastic sheet or expanded polytetrafluoroethylene (ePTFE) sheet.

In yet a further aspect, a light source comprising an LED mixing chamber is disclosed. The mixing chamber comprises a sheet substrate with a color shifting layer in contact with a portion of the inner surface of the mixing chamber. The color shifting layer can comprise an optically transparent binder. The sheet substrate can be a plexifilimentary film fibril sheet, microporous PET sheet, foamed microcellular polyolefin (PET or PP), highly pigmented plastic sheet or expanded polytetrafluoroethylene (ePTFE) sheet. Further, an optional polymer layer can be disposed between the inner surface and the color shifting layer.

### BRIEF DESCRIPTION OF THE FIGURES

FIG. 1a is a cross section of one aspect of the diffusive light reflector with color shift layer.

FIG. 1b is a cross section of another aspect of the diffusive light reflector with color shift layer and optional polymer layer.

FIG. 2 shows the configuration of the Direct remote phosphor LED mixing chamber used in several experiments.

FIG. 3 shows the configuration of the Indirect optic system LED module used in several experiments.

FIG. 4 shows the reflectance verses wave length of a diffusive light reflector without the color shift layer and three aspects of the disclosed diffusive light reflector with the color shift layer.

FIG. 5 shows the spectral response of a diffusive light reflector without the color shift layer and three aspects of the disclosed diffusive light reflector with the color shift layer.

FIG. 6 shows the luminous flux of a diffusive light reflector without the color shift layer and three aspects of the disclosed diffusive light reflector with the color shift layer.

FIG. 7 shows the reflectance verses wave length of a diffusive light reflector without the color shift layer and five aspects of the disclosed diffusive light reflector with the color shift layer when used in a LED mixing chamber.

FIG. 8 shows the spectral response of a diffusive light reflector without the color shift layer and five aspects of the disclosed diffusive light reflector with the color shift layer when used in a LED mixing chamber.

FIG. 9 shows the luminous flux of a diffusive light reflector without the color shift layer and five aspects of the disclosed diffusive light reflector with the color shift layer when used in a LED mixing chamber.

### DETAILED DESCRIPTION

A diffusive light reflector is disclosed, which comprises a sheet substrate having a first side and a second side, wherein the first side is adapted to be adjacent to an LED light source, and a color shifting layer on the first side of the sheet.

The sheet substrate can be a plexifilimentary film fibril sheet, microporous PET sheet, foamed microcellular polyolefin (PET or PP), highly pigmented plastic sheet or expanded polytetrafluoroethylene (ePTFE) sheet. Plexifilimentary film fibril sheets suitable for use with the diffusive light reflector are disclosed in U.S. application Ser. No. 12/728,164, herein incorporated by reference in its entirety. The film-fibril sheet has two sides, where on side is adapted to be adjacent to a light source. That is, the film-fibril sheet is designed to be installed into a lighting fixture where one side or face will be facing the light source and will incorporate the color shifting layer and optional polymer layer. Light emitted from the light source passes through the color shifting layer and is reflected from this face to be directed out of the light fixture to improve fixture brightness, light distribution, and create a wider wavelength of light.

Microporous PET (polyethylene terephthalate) sheets, such as DuPont Teijin Films UX series or Toray's LuMirror E60L films, can also be used as the sheet substrate. Suitable ePTFE sheets include those disclosed in U.S. Pat. No. 5,781,342 herein incorporated by reference in its entirety.

The color shifting layer shifts “cold” high color temperature LED light, e.g., blue or UV LED light, to warmer, lower color temperature light. For example, blue LED light at a color temperature of greater than 5000 Kelvin CCT, including 5700 Kelvin CCT, is shifted to light at a color temperature of about 4000 Kelvin CCT, including about 4500 Kelvin CCT, and about 5000 Kelvin CCT. Further, the color shifting layer maintains a relatively consistent Color Rendering Index (CRI) of around 70 Ra. Also, the color shifting increases the wave length of the LED light so less light is absorbed by the film-fibril sheet substrate. For example, low wavelength light from a blue LED (e.g. from about 400 nm to about 500 nm), is shifted to light at a wave length of greater than about 420 nm.

The color shifting layer can comprise a photoluminescent, such as a yellow phosphor material. Suitable yellow phosphor materials include cerium-doped yttrium aluminum garnet. Other photoluminescents include europium-doped strontium-barium silicate phosphor, terbium-doped yttrium oxide; europium-doped yttrium oxide, europium-doped lutetium oxide, praseodymium-doped calcium titanium oxide, europium-doped calcium oxide, europium-doped gadolinium zinc oxide, samarium-doped zirconium oxide, europium-doped zirconium oxide, europium-doped yttrium vanadium oxide, phosphate-doped lanthanum, cerium, terbium oxides, doped materials consisting of a host matrix (e.g. Gd₂O₃, GdO₂S, PbO, ZnO, ZnS, ZnSe) and a dopant (Eu, Tb, Tm, and Mn), and metal-doped forms of zinc sulfide and zinc selenide (e.g. ZnS:Mn²⁺, ZnS:Cu⁺). Quantum dots, such as semiconductor nanocrystals and cadmium-selenide nanocrystalline core surrounded by a zinc sulfide shell capped with organic ligands such as trictylphosphine oxide, can also be used in the color shift layer. The nanocrystalline core of quantum dots may be fabricated from a variety of materials including, but not limited to, silicon, germanium, indium phosphide, indium gallium phosphide, cadmium sulfide, cadmium selenide, lead sulfide, copper oxide, copper selenide, gallium phosphide, mercury sulfide, mercury selenide, zirconium oxide, zinc oxide, zinc sulfide, zinc selenide, zinc silicate, titanium sulfide, titanium oxide, and tin oxide. The color shifting layer can also comprise an optically transparent binder at a weight percent of from about 5% to about 25%, including 10%, 15%, and 20%. Such binder can include polyolefins, polyesters, polyacrylates, polyurethanes, and blends thereof. Example polyolefins include high density polyethylene, low density polyethylene, and polyethylene methacrylate copolymers. The optically transparent binder serves to bind the photoluminescent material to the film-fibril sheet and protect the film-fibril sheet.

Also, the transparent binder imparts a matte-finish topography to the film-fibril sheet, which lowers the gloss level and increase reflectance. Reflectance values of the transparent binder on the film-fibril sheet can range from about 94% to about 100%, including about 95%, 96%, 97%, 98%, and 99%, measured at 550 nm. The transparent binder can cause the diffusive light reflector to have an average (mean) roughness (Ra) from about 6.4 microns to about 2.8 microns, including from about 6.0 microns to about 3.0 microns, and about 3.5 microns measured at 5× magnification. Further, the range in average surface roughness (i.e. roughness uniformity) of the diffusive light reflectors is less than about 1 micron, including less than about 0.8 microns, less than about 0.6 microns, and about 0.4 microns. Roughness measurement techniques are disclosed in U.S. application Ser. No. 12/728,164.

The color shifting layer has a thickness between about 5 microns to about 50 microns, including about 10 microns, about 15 microns, about 20 microns, about 25 microns, about 30 microns, about 35 microns, about 40 microns, about 45 microns, and ranges in between. The disclosed diffusive light reflectors with the color shift layer can have a reflectance from about 94% to about 120% measured at 560 nm, including about 95%, 96%, 97%, 98%, 99%, 100%, 105%, 110%, 115%, from about 98% to about 120%, from about 98% to about 115%, from about 98% to about 110%, and from about 98% to about 105%, measured at 550 nm.

The color shift layer can be applied to the substrate using known techniques, including extrusion, spraying, imbibing, dipping, printing, painting, and roll coating.

The optional polymer layer imparts a matte-finish topography to the film-fibril sheet substrate, which lowers gloss level and increases reflectance. The polymer layer can be applied to the substrate using known techniques, including extrusion, spraying, imbibing, dipping, painting, printing, and roll coating. Suitable polymer layers and their properties are disclosed in U.S. application Ser. No. 12/728,164, herein incorporated by reference in its entirety.

The diffusive light reflector can be affixed to steel, including coil steel, aluminum, or other flexible articles, such as plastics, to create a formable reflective surface. The reflector can be affixed to coil steel or aluminum using any known means, such as bonding with a hot melt adhesive, lamination, or autoclaving. Suitable adhesives include polyethylene, such as low density polyethylene, ethylene methyl acrylate copolymer (EMA) based hot melt adhesives, or an epoxy adhesive containing acrylic polymer, such as methacrylate. The laminate of the reflector and the coil steel or aluminum sheet can then be formed according to known processing techniques to form the laminate to the desired shape. The reflector-metal laminate can be handled in metal forming operations such as stamping, rolling, and punching without oil soaking into the pores of the plexifilamentary film-fibril sheet, thus eliminating the need for a removable protective film cover during manufacture of lighting fixtures. The reflector can be affixed to plastic using known adhesives or low temperature curing epoxies.

The lighting fixture is formed by applying the reflector laminate to any surface for use in lighting fixtures such as luminaries, lighted signs, daylighting reflectors, or backlights. Suitable surfaces include, but are not limited to, flexible planar substrates, rigid substrates, such as lighting fixture housings, coil steel or aluminum sheet, low-cost semi-flexible polyester sheet and the like. Backlights are commonly used in liquid crystal display panels.

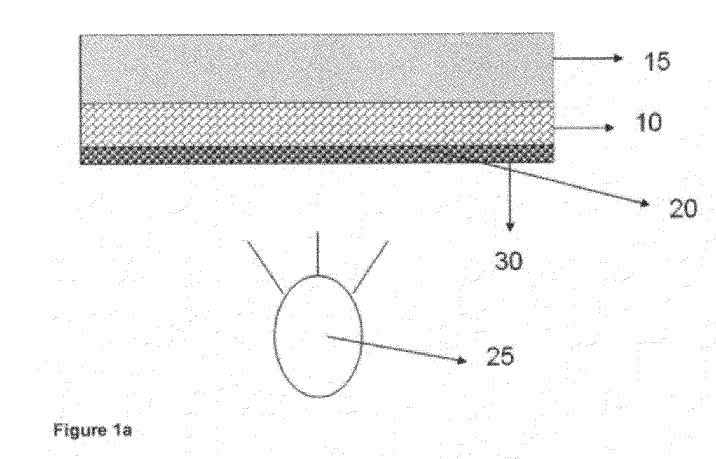

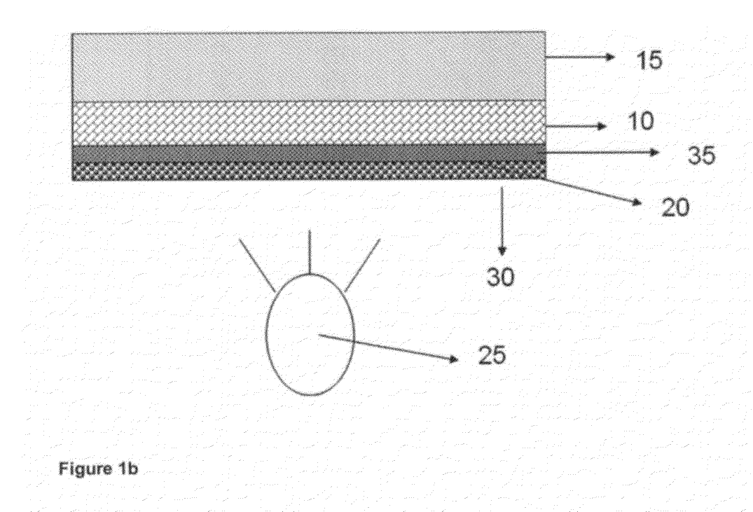

FIGS. 1a and 1b show two aspects of the disclosed diffusive light reflector with the color shift layer. Plexifilimentary film-fibril sheet substrate 10 is disposed on aluminum sheet 15. First side 20 of film-fibril sheet 10 is positioned adjacent light source 25. Color shifting layer 30 is disposed on the first side. The optional polymer layer 35 is disposed between film-fibril sheet 10 and color shifting layer 30. Note that FIG. 1 is for illustrative purposes only. The film-fibril sheet with color shifting layer and optional polymer layer can extend downward and be adjacent to the sides of the light source, forming a cup or bowl around the light source. Also, just the film-fibril sheet can extend downward. Furthermore, the light source can be placed in an opening within the center of the diffusive light reflector, so that it partially or wholly protrudes through the center opening.

Further disclosed is a method of color shifting a LED light. Here, a LED light source at a CCT value of greater than 5000 Kelvin is provided, where the LED light is directed onto a diffusive light reflector having a color shift layer. A portion of the higher temperature LED light is than shifted to a longer wavelength (e.g. 420 nm or greater) with a cooler (e.g. 4000 Kelvin) CCT temperature and reflected back. The higher CCT LED light can comprise LED light that emits light at a frequency range from about 400 nm to about 500 nm; for example blue LED light. Suitable diffusive light reflectors are disclosed above.

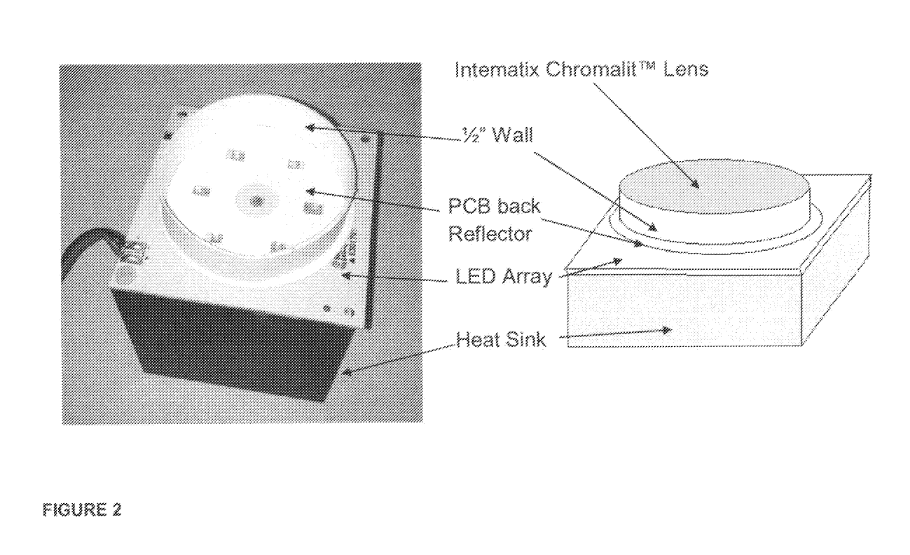

Also disclosed is a light source comprising an LED mixing chamber. The mixing chamber comprises the sheet substrate described above with the disclosed color shifting layer in contact with a portion of the inner surface of the mixing chamber. A mixing chamber allows single or multiple high lumen density LED light point sources to be mixed efficiently to make a uniform light. Mixing chamber refers to a design where LEDs are arranged on a back panel in a cavity, light is projected directly and reflected off of the side walls of the cavity before passing through a lens. The depth of the cavity allows the omnidirectional or wide-angle light emitted from the LED to bounce and mix and be more uniformly imaged on the chamber lens. Light reflected back off the lens is also recycled back into the chamber. It is important to have a highly reflective surface within such a chamber so that minimal light is lost with each reflection. In addition to providing a uniform image, mixing chambers are also used to mix multiple LED colors. With remote phosphor arrangement using blue LEDs and a phosphor coated lens, the mixing chamber allows the light to be uniformly projected on the lens phosphor surface and recycles back reflections off the lens for improved conversion efficiency. As shown in FIG. 2, the inner surface of the mixing chamber has a back reflector and side wall. The sheet substrate with the color shifting layer can be disposed on a portion of the back reflector and side wall, just a portion of the side wall, or just a portion of the back reflector. A lens sits on the top portion of the wall.

### EXAMPLES

### Sample Composition and Preparation

The following seven samples were used in the below experiments. Sample 1 is a WhiteOptics F-23 (aka White97) reflector comprised of a 175 micron thick flashspun plexifilimentary fiber sheet material coated on both sides with a 25 micron thick mixture of high density polyethylene and polyethylene. Sample 2 is a sheet of F-23 reflector material coated with 25 microns of aliphatic polyurethane dispersion containing the following color shift layer composition (EY4750 Color Shift composition):

| Component | Manufacturer | wt(g) | wt % |
|---|---|---|---|
| Witco 781 Polyurethane | Chemtura | 55.92 | 89.8% |
| dispersion | | | |
| Dispersant L-7608 | Momentive | 0.63 | 1.0% |
| Dowanol | Dow | 0.64 | 1.0% |
| Dynoadd 506 acrylic | Dynea | 1.2 | 1.9% |
| beads | | | |
| Byk 088 defoamer | Byk | 2 | 3.2% |
| EY4750 phosphor | Intematix | 1.9 | 3.1% |

The EY4750 phosphor is an europium doped strontium-barium silicate phosphor by Internatix (Fremont, Calif.). Sample 3 is a sheet of F-23 reflector material coated with 25 microns aliphatic polyurethane dispersion containing the following color shift layer composition (O5446 Color Shift composition):

| Component | Manufacturer | wt(g) | wt % |
|---|---|---|---|
| Witco 781 | Chemtura | 55.95 | 89.8% |
| Polyurethane | | | |
| dispersion | | | |
| Dispersant L-7608 | Momentive | 0.61 | 1.0% |
| Dowanol | Dow | 0.6 | 1.0% |
| Dynoadd 506 acrylic | Dynea | 1.26 | 2.0% |
| beads | | | |
| Byk 088 defoamer | Byk | 4.06 | 6.5% |
| O5446 phosphor | Intematix | 1.75 | 2.8% |

The O5446 phosphor is an europium doped strontium-barium silicate phosphor by Internatix (Fremont, Calif.). Sample 4 is a sheet of F-23 reflector material coated with 25 microns of a 50/50 wt. % blend of O5446 Color Shift composition and EY4750 Color Shift composition. Sample 5 is a WhiteOptics F-16 reflector comprised of a 150 micron thick biaxially expanded microporous PET (DuPont Teijin Films UX film) material coated on the top side with a 20 micron polyurethane layer. Sample 6 is a sheet of the F-16 reflector material coated with the O5446 Color Shift composition. Sample 7 is a sheet of the F-16 reflector material coated with a 50/50 wt. % blend of the O5446 Color Shift composition and EY4750 Color Shift composition.

Each color shift composition is made by combining phosphor, dispersing agents and solvents into pigment “pregrind” then dispersing under high shear for a short period using a lab rotor-stator mixer. Binder dispersion and other components were then mixed in under moderate shear using a knife-blade mixer. The color shift composition was coated onto the reflector sheet substrates using Mayer rod then cured in an oven at 110° C. for 4 minutes.

Light Fixture Description and Experiments

Direct “remote phosphor” lens mixing chamber: The chamber used a Future Lighting Solutions LM1_R06S707_V2 LED, 65 mm diameter 6-LED array using Philips Luxeon Rebel ES Royal Blue LEDs with 435 nm dominant wavelength mounted on a 6.8 cm×6.8 cm×6.8 cm machined aluminum heat sink with heat sink compound. The mixing chamber consists of the LED array, back reflector, reflective ring, and ChromaLit Lens (see FIG. 2). The back reflector sits on top of the LED array and has holds for LEDs to shine through. The reflective ring is placed on the back reflector (or directly on the LED array for a baseline) and makes up the wall of the mixing chamber. For “baseline” tests, the wall of the mixing chamber was a white painted metal. For the reflector tests both with and without phosphor coating, both the wall (ring) and backplane were covered with the coated reflector surface. A ChromaLit 4000 k 80CRS 61.5 mm lens from Intermatix is then placed matte side down on top of the reflective ring so that the light emitted from the LED must pass through the lens before entering the test integrating sphere.

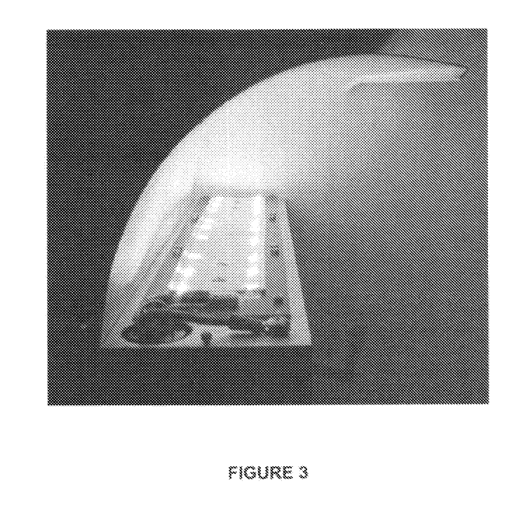

Indirect optic system: This system used a Digital Lumens (Boston, Mass.) light module using 18, 1 watt, 5000 k color temperature LEDs fitted with a WhiteOptics circuit board back-reflector and WhiteOptics curved reflector to generate predominately indirect-reflected light. (See FIG. 3).

Luminous Flux “φv” is the basic photometric quantity and describes the total amount of electromagnetic radiation emitted by a source, spectrally weighted with the human eye's spectral luminous efficiency function V(λ). Luminous flux is the photometric counterpart to radiant power. The unit of luminous flux if lumen (lm), and at 555 nm, where the human eye has its maximum sensitivity, a radiant power of 1 W corresponds to a luminous flux of 683 lm.

Color Rendering Index “CRI” specifies the quality of the color rendering of illuminants. The CRI is calculated by comparing the color rendering of a sample source to that of a reference source. For example, black body radiators with a CCT below 5000 k as compared to a day light source like D65 with a CCT higher than 5000 k. A selection of reflective test color samples (TCS), specified by the CIE are used to calculate the CRI of a test lamp. The first eight samples with relative low saturation are used to calculate the general CRI Ra of a light source. (BTS256-LED Tester Operator Manual).

Reflectance measurements of coated materials were obtained using an X-Rite SP62 Integrating sphere spectrophotometer (X-Rite, Grand Rapids, Mich.) with 8 mm measurement area, d/8° spectral engine 10° observer calibrated to a factory matched white standard. The output is percent reflectance at each wavelength and the spectral range measured is 400 nm to 700 nm in 10 nm intervals. For each sample, 5 readings were taken randomly across a 10 cm area and averaged to account for variation in the coating. Specular component of the measurement was included.

Light output and Spectral response of both the Indirect and Direct (Mixing chamber) systems was measured in an 8 foot diameter spherical integrating room using a BTS256-LED Spectroradiometer (Gigahertz Optik, Pucheim Germany) with detector behind a diffusing baffle. The integrating cavity is lined with 98% reflectance, fully diffuse reflector material (DuPont DLR80, E.I. DuPont de Nemours, Wilmington, Del.). The spectroradiometer is calibrated with an integrated factor calibration illumination source to obtain absolute luminous flux with individual LED emitters, which is then used to calibrate the integrating sphere. LED systems are placed in the integrating room and connected to regulated DC power supply. Power is run at constant current. Tests are run for 30 minutes to allow the LEDs to warm up and come to equilibrium.

### Example 1

### Reflectance Measurement

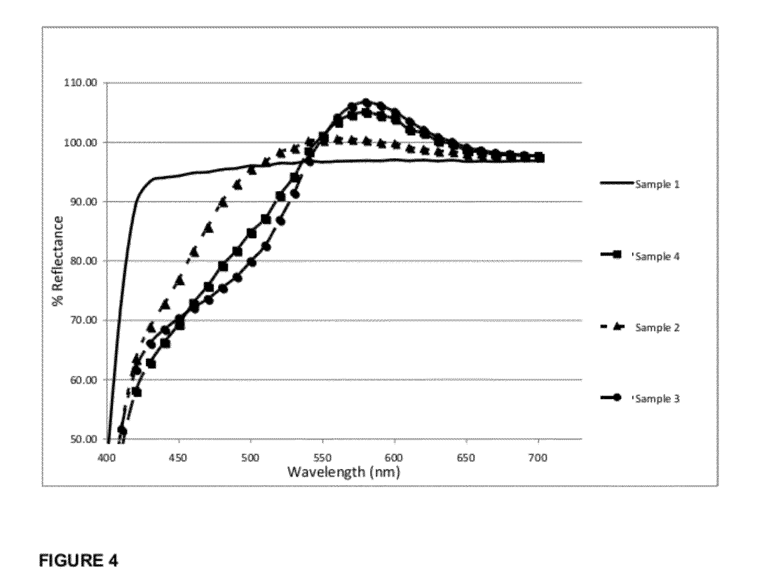

Example 1 measures the reflectance of a diffusive light reflector without color shift layer (Sample 1), and three aspects of the disclosed diffusive light reflector with color shift layer (Samples 2-4). Results are reported in FIG. 4. Here, the diffusive light reflectors with color shift layer (Samples 2-4) showed improved reflectance between 550 nm and 650 nm over a reflector without the color shift layer (Sample 1). Furthermore, between about 560 nm and 640 nm, the reflectance of the disclosed reflectors with color shift layer is greater than 100%, indicating a color shift from the cooler LED blue light to a warmer white light. The LED light source was the indirect optic system described above.

### Example 2

### Spectral Response

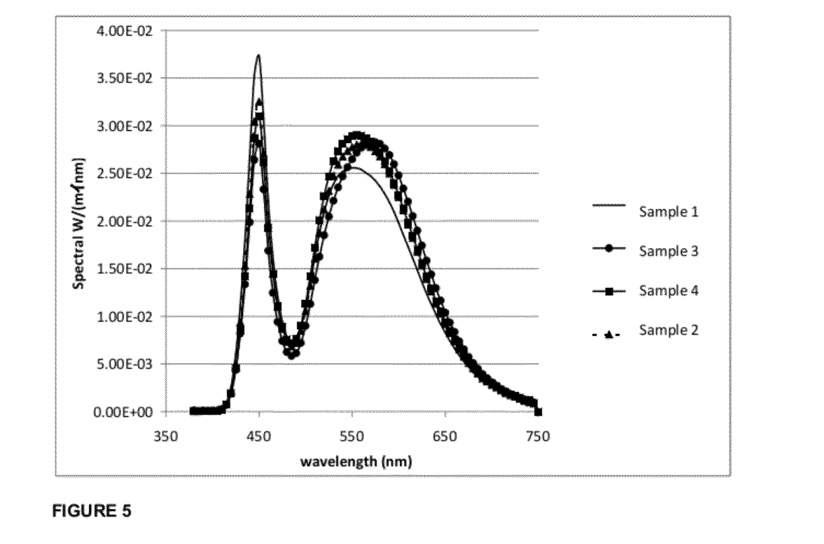

Example 2 measures spectral response as a function of wave length (nm) of Samples 1-4, shown in FIG. 5. Here, Samples 2-4 showed an increase in spectral response and a shift in the spectrum, which indicates increased efficiency and white light output. Further, Samples 2 and 3 showed a decrease in CCT from 5790 Kelvin (Sample 1) to 4440 Kelvin and 4380 Kelvin, respectively. Also, the CRI remained relatively constant from 72.1 Ra (Sample 1) to 70.0, 69.2, and 68.8 for Samples 2-4, respectively. The LED source was the indirect optic system described above.

### Example 3

### Light Output

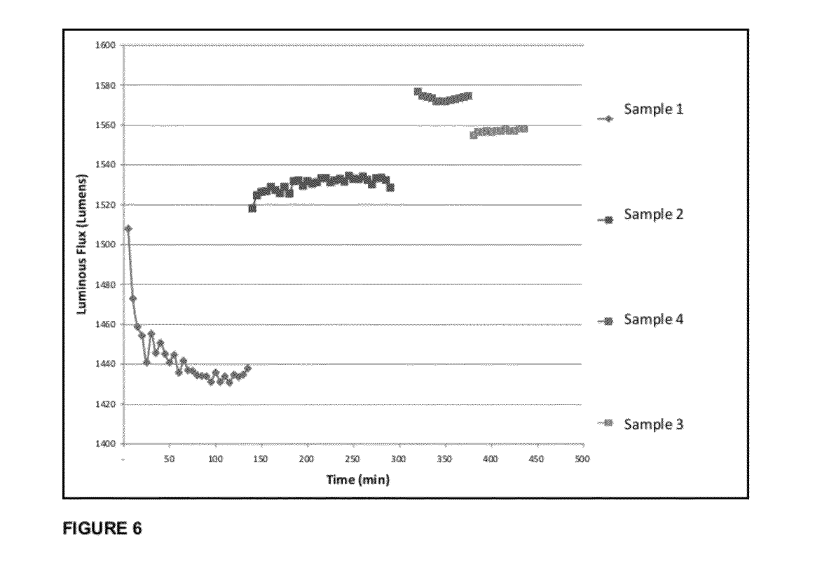

Example 3 measures light output as a function of time of Samples 1-4, shown in FIG. 6. The LED source was the indirect optic system described above.

### Example 4

### Mixing Chamber Reflectance

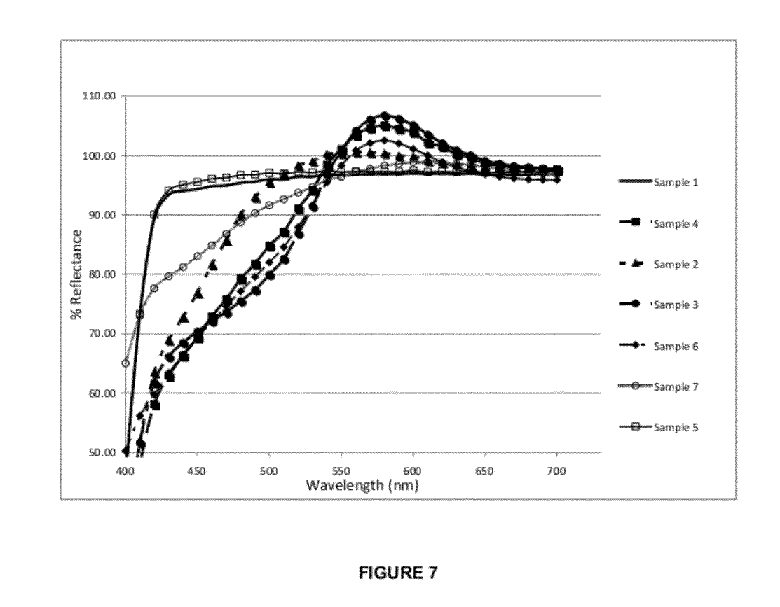

Example 4 measures the reflectance of a diffusive light reflector without color shift layer (Samples 1 and 5), and five aspects of the disclosed diffusive light reflector with color shift layer (Samples 2-4, and 6-7). Results are shown in FIG. 7.

### Example 5

### Mixing Chamber Spectral Response

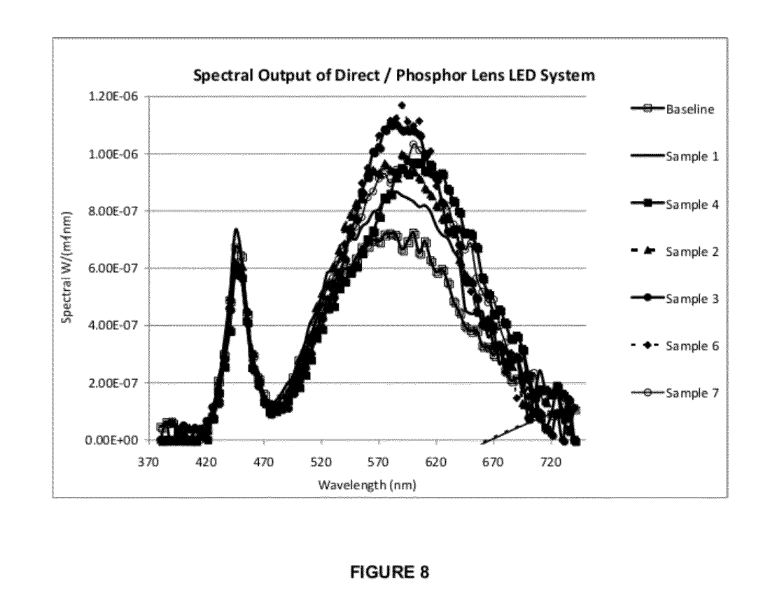

Example 5 measures reflective flux as a function of wave length (nm) of Samples 1-4, and 6-7, shown in FIG. 8. Also included is 87% white paint coating (baseline).

### Example 6

### Mixing Chamber Light Output

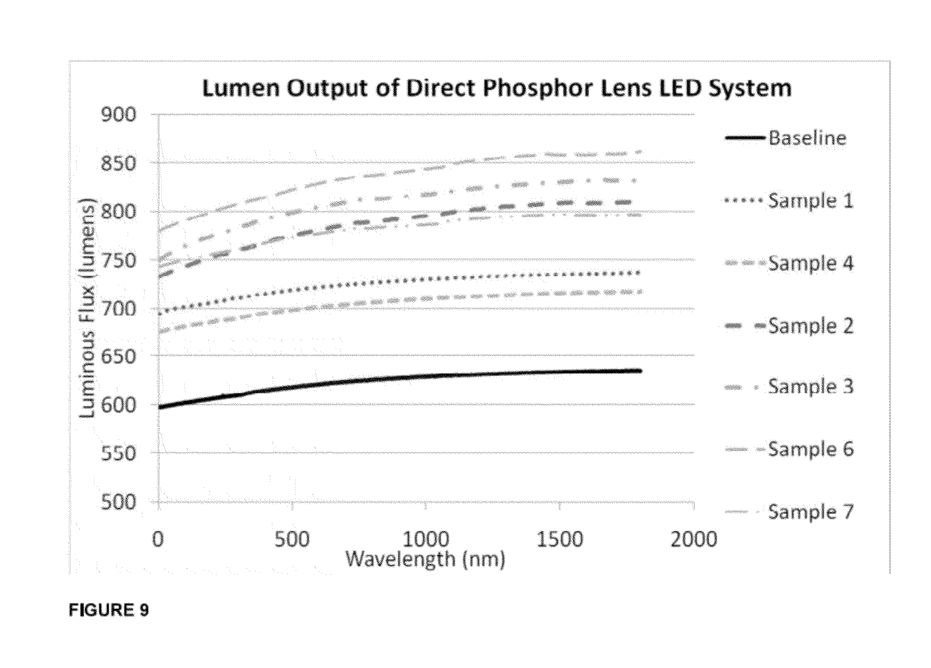

Example 6 measures light output as a function of time of Samples 1-4, and 6-7, shown in FIG. 9. The LED source and sample configuration is the same as Example 4.

Below is a summary experimental data chart for each of the above samples and baselines.

| | | | | Luminous | | | |
|---|---|---|---|---|---|---|---|
| | reflector | Color shift | | Flux | | | Color |
| System | substrate | composition | Sample No. | (Lumens) | | CRI(a) | Temp |
| | | | | | Relative | | |
| | | | | | Increase | | |
| | | | | | over | | |
| | | | | | WhiteOptics | | |
| | | | | | without | | |
| | | | | | Phosphor | | |
| Indirect | WhiteOptics F23 | none | Sample 1 | 1431 | | 72.1 | 5790 |
| | WhiteOptics F23 | O5446 | Sample 3 | 1533 | 7.2% | 70 | 4440 |
| | WhiteOptics F23 | 50-50 | Sample 4 | 1573 | 7.8% | 68.8 | 5063 |
| | WhiteOptics F23 | EY4750 | Sample 2 | 1558 | 6.7% | 69.3 | 5083 |
| | | | | | Relative | | |
| | | | | | Increase | | |
| | | | | | over white | | |
| | | | | | paint | | |
| Direct | white paint | none | Baseline | 635.2 | N/A | 76.8 | 3826 |
| with | WhiteOptics F23 | none | Sample 1 | 737.4 | 16% | 76.5 | 3581 |
| Intematix | WhiteOptics F23 | 50-50 | Sample 4 | 718.3 | 13% | 80.0 | 2828 |
| Phosphor | WhiteOptics F23 | EY4750 | Sample 2 | 810.3 | 28% | 72.3 | 3438 |
| lens | WhiteOptics F23 | O5446 | Sample 3 | 832.4 | 31% | 67.8 | 3063 |
| | white paint | | Baseline | 630.8 | N/A | 76.9 | 3807 |
| | | | (retest) | | | | |
| | WhiteOptics F16 | O5446 | Sample 6 | 862.4 | 37% | 68.7 | 3102 |
| | WhiteOptics F16 | 50-50 | Sample 7 | 797.9 | 27% | 77.2 | 3138 |

The invention has been described above with reference to the various aspects of the disclosed diffusive light reflector with color shift layer, methods of shifting higher CCT LED light, and laminates and luminaries made from the disclosed diffusive light reflectors. Obvious modifications and alterations will occur to others upon reading and understanding the proceeding detailed description. It is intended that the invention be construed as including all such modifications and alterations insofar as they come within the scope of the claims

What is claimed is:

1. A diffusive light reflector comprising a sheet substrate having a first side and a second side, wherein said first side is adapted to be adjacent to a LED light source; and a color shifting layer on said first side of said sheet substrate.

2. The diffusive light reflector of claim 1, wherein said sheet substrate is selected from the group consisting of a plexifilimentary film fibril sheet, a microporous PET sheet, foamed microcellular polyolefin (PET or PP), highly pigmented plastic sheet and a expanded polytetrafluoroethylene (ePTFE) sheet.

3. (canceled)

4. (canceled)

5. The diffusive light reflector of claim 1, wherein said color shifting layer comprises an optically transparent binder.

6. The diffusive light reflector of claim 1, wherein said color shifting layer comprises a photoluminescent.

7. The diffusive light reflector of claim 6, wherein said photoluminescent is a yellow phosphor material.

8. The diffusive light reflector of claim 7, wherein said yellow phosphor material is cerium-doped yttrium aluminum garnet.

9. The diffusive light reflector of claim 6, wherein said photoluminescent is europium doped strontium-barium silicate phosphor.

10. The diffusive light reflector of claim 1, wherein said color shifting layer comprises quantum dots.

11. (canceled)

12. The diffusive light reflector of claim 5, wherein said optically transparent binder is selected from the group consisting of polyolefin, polyester, polyacrylate, polyurethane and blends thereof.

13. The diffusive light reflector of claim 1, having a reflectance from about 94% to about 120% measured at 560 nm.

14.-17. (canceled)

18. The diffusive light reflector of claim 1, wherein said color shifting layer has a thickness between about 5 microns and about 50 microns.

19. (canceled)

20. The diffusive light reflector of claim 1, wherein said color shifting layer is extruded on said first side of said sheet.

21. The diffusive light reflector of claim 1, further comprising a polymer layer between said first side of said sheet substrate and said color shifting layer, wherein said polymer layer is selected from the group consisting of polyolefin, polyester, polyacrylate, and blends thereof.

22.-28. (canceled)

29. The diffusive light reflector of claim 21, wherein said polymer layer comprises at least one component selected from the group consisting of titanium dioxide and barium sulfate at an amount greater than about 3 to about 20 weight percent of said polymer layer.

30. (canceled)

31. A laminate comprising the reflector of claim 1 affixed to a steel, aluminum, or plastic sheet.

32. A reflector comprising a color shift layer, wherein said color shift layer lowers color temperature by about 500 to about 1500 Kelvin CCT without reducing total light output when used with an LED light source.

33. (canceled)

34. A lighting fixture comprising the laminate of claim 31, wherein said light fixture is selected from the group consisting of luminaries, lighted signs, daylighting reflectors, or backlights.

35. (canceled)

36. A method of color shifting a LED light comprising: (a) directing light from a LED light source onto a diffusive light reflector, wherein said reflector comprises a color shifting layer and said LED source has a CCT value of greater than 5000 Kelvin; (b) shifting a portion of said LED light to a longer wavelength; and (c) reflecting said longer wavelength light.

37.-59. (canceled)

60. The diffusive light reflector of claim 1, wherein said color shifting layer lowers color temperature by about 500 to about 1500 Kelvin CCT without reducing total light output when used with an LED light source.

61. The method of claim 36 wherein said color shifting layer lowers color temperature by about 500 to about 1500 Kelvin CCT without reducing total light output when used with an LED light source.
